(19) United States
(12) Patent Application Publication
(10) Pub. No.: US 2008/0066672 A1
(43) Pub. Date: Mar. 20, 2008

(54) Watercraft having inclining seat

(75) Inventors: Trent Allan Eekhoff, Grand Rapids, MI (US); Dale Edward Eekhoff, Grand Rapids, MI (US)

Correspondence Address: BAKER & DANIELS LLP, 300 NORTH MERIDIAN STREET, SUITE 2700, INDIANAPOLIS, IN, 46204, US

(73) Assignee: Bennington Marine LLC, Elkhart, IN (US)

(21) Appl. No.: 11/901,927

(22) Filed: Sep. 19, 2007

Related U.S. Application Data
(60) Provisional application No. 60/826,292, filed on Sep. 20, 2006.

(51) Int. Cl. B63B 17/00; B60N 2/02; B60N 2/52

(52) U.S. Cl. 114/363; 297/311; 297/317; 297/344.1; 297/463.1

(57) ABSTRACT

An adjustable seat having an upright position and an inclined position for use on a watercraft, wherein the seat includes a frame; a movable seat bottom having an upper surface that is at a greater angle relative to the horizontal in the inclined position than in the upright position; and a movable seat back that is at a greater angle relative to the vertical in the inclined position than in the upright position. A rear portion of the seat bottom may be located lower in the inclined position than in the upright position, and the seat back may be located lower in the inclined position than in the upright position. The adjustable seat may include a gas-assist strut connected between the frame and one of either the seat bottom or the seat back. The frame may include at least one slot to facilitate movement of the adjustable seat from the upright position to the inclined position, and the seat may further include a support member movable in the slot. The frame may include three slots on each side of the seat, and support members located in each of the slots. The support members can be rods, two of which are attached to the seat bottom, and one being attached to the seat back. The slot may include a ramp section and a step portion, with the support member being located on the step section when the seat is in the upright position, and the support member being located at the bottom of the ramp when the seat is in the inclined position.

This application claims priority to Provisional patent application Ser. No. 60/826,292, filed Sep. 20, 2006.

### BACKGROUND OF THE INVENTION

This invention is directed to a seat for use on a vehicle, and in particular, to an adjustable seat that has an inclined position that may be used on a watercraft, such as on a pontoon boat.

Most vehicles include some form of seat for the occupants. It is common in watercraft, such as pontoon boats and other boats, to include padded seats having a seat bottom and a seat back for passengers. As watercrafts are often used for relaxation, it would be desirable to provide an adjustable seat that is suitable for use on a watercraft that would provide an inclining or reclining position.

It is an object of the subject invention to provide an inclining seat that may be used in a vehicle, such as a watercraft. A further object of the invention is to provide a manually adjustable inclining seat, which may be equipped with a padded seat bottom and a seat back, and wherein the seat bottom may extend out and the seat back incline down from an upright position.

### SUMMARY OF THE INVENTION

It is a feature of the invention to provide in one embodiment a watercraft, including a deck, an engine, and at least one adjustable seat, including a seat bottom and a seat back, the seat being adjustable from an upright position to an inclined position, wherein the seat bottom is located forward from the location of the seat bottom in the upright position.

A rear portion of the seat bottom may be located lower in the inclined position than in the upright position. An upper surface of the seat bottom may be at a greater angle relative to the horizontal in the inclined position than in the upright position.

The seat back may be located lower in the inclined position than in the upright position. The seat back may also be at a greater angle relative to the vertical in the inclined position than in the upright position.

The seat bottom and the seat back can be pivotally connected to one another with a hinge.

The seat may further include a frame with slots that facilitate the adjustment of the seat. The frame may also include a pair of ends, one each on opposite sides of the seat back and the seat bottom, with three slots in each end. Two of the slots on each end may be straight and one of the slots in each end may include an angled portion.

The watercraft may also include at least one support member attached to either the seat back or the seat bottom, with an end of the support member located in one of the slots of the frame. The seat may be moved from the upright position to the inclined position by sliding the end of the support member in the slot. The watercraft may include three support members, two of which are attached to the seat bottom and one support member attached to the seat back.

The seat may further include a headrest mounted to the frame. The seat bottom and the seat back may be movable relative to the headrest.

The seat may be manually movable between the upright position and the inclined position.

The seat may further include a latch mechanism to lock the seat in the upright position. The latch mechanism may include first and second linking members that are aligned in an over-center position when locking the seat in the upright position.

It is another feature of the invention to provide an embodiment of a watercraft including a deck, an engine, and at least one adjustable seat, having a seat bottom and a seat back, wherein the seat is adjustable from an upright position to an inclined position, and the seat back is at a greater angle relative to the vertical in the inclined position than in the upright position.

The seat back may also be located lower in the inclined position than in the upright position. In the inclined position, the seat bottom may be located forward of the location of the seat bottom in the upright position, and the seat bottom may be at a greater angle relative to the horizontal in the inclined position than in the upright position.

The seat bottom and the seat back may be pivotally connected to one another.

The seat can include a frame with slots that facilitate the adjustment of the seat. The frame may have two ends located on opposite sides of the seat back and the seat bottom with three slots in each end. Two of the slots in each end may be straight, and one of the slots in each end may have an angled portion.

The seat may further include at least one support member, and ends of the support member can be located in the slots, with the ends of the support member sliding in the slots when moving the seat from the upright position to the inclined position.

The watercraft may further include a headrest mounted to the frame, with the seat back and the seat bottom being movable relative to the headrest.

The watercraft may further include a latch mechanism for locking the seat in the upright position. The latch mechanism may include at least one resilient member biasing the latch mechanism to a locked position.

It is also a feature of the invention to provide an embodiment of an adjustable seat having an upright position and an inclined position for use on a watercraft, wherein the seat includes a frame; a movable seat bottom, a portion of the seat bottom being lower in the inclined position than in the upright position; and a movable seat back, such that the seat back is lower in the inclined position than the upright position.

The seat back and the seat bottom can be pivotally connected to one another, and the seat back and the seat bottom may be padded. In the inclined position, the seat bottom may be located forward from the location of the seat bottom in the upright position, and an upper surface of the seat bottom may be at a greater angle relative to the horizontal in the inclined position than in the upright position.

The frame may include slots that facilitate the adjustment of the seat, and the frame may further include a pair of ends, one each on opposite sides of the seat back and the seat bottom, wherein the slots are located. At least one of the slots may include a ramp section and a step section. The adjustable seat may further include a support member having an end in the slot that includes the ramp section, with the support member being located in the step section when the seat is in the upright position and being located at the bottom of the ramp section when the seat is in the inclined position.

The adjustable seat may include three slots in each end of the frame and a support member movable in each slot, with the support members sliding in the slots to move the adjustable seat from the upright position to the inclined position.

The adjustable seat may also include a headrest mounted to the frame, with the seat back and the seat bottom being movable relative to the headrest.

The adjustable seat may also include at least one gas-assist strut to aid in raising the seat to the upright position.

The adjustable seat may further include a latch mechanism to lock the seat in the upright position. The latch mechanism may include pivoting linking members and a release member to pull the linking members from an over-center position.

It is a further feature of the invention to provide an embodiment of an adjustable seat having an upright position and an inclined position for use on a watercraft, wherein the seat includes a frame; a movable seat bottom having an upper surface that is at a greater angle relative to the horizontal in the inclined position than in the upright position; and a movable seat back that is at a greater angle relative to the vertical in the inclined position than in the upright position.

A rear portion of the seat bottom may be located lower in the inclined position than in the upright position, and the seat back may be located lower in the inclined position than in the upright position.

The adjustable seat may include a gas-assist strut connected between the frame and one of either the seat bottom or the seat back.

The frame may include at least one slot to facilitate movement of the adjustable seat from the upright position to the inclined position, and the seat may further include a support member movable in the slot. The frame may include three slots on each side of the seat, and support members located in each of the slots. The support members can be rods, two of which are attached to the seat bottom, and one being attached to the seat back. One slot may include a ramp section and a step section, with the support member being located on the step section when the seat is in the upright position, and the support member being located at the bottom of the ramp when the seat is in the inclined position.

It is an additional feature of the invention to provide an embodiment of an adjustable seat having an upright position and an inclined position for use on a watercraft, wherein the seat includes a frame having at least one slot; a movable seat bottom; a movable seat back; and a support member movable in the slot, to move the seat from the upright position to the inclined position.

The slot may include a ramp section and a step section, wherein the support member is in the step section when the seat is in the upright position and is at the bottom of the ramp section when the seat is in the inclined position. The frame may include three slots on each side of the seat, and a support member in each of the slots. The support members can be rods, and two of the rods can be attached to the seat bottom, and one of the rods can be attached to the seat back.

The seat bottom and the seat back can be pivotally connected to one another.

The adjustable seat may further include a latch mechanism having first and second linking members, wherein the first linking member is pivotally connected to the support member. The second linking member may have an L-shaped configuration, and one leg of the L-shaped member bears against the frame to limit movement of the latch mechanism.

It is another feature of the invention to provide an embodiment of an adjustable seat having an upright position and an inclined position for use on a watercraft, wherein the seat includes a frame having at least one slot with a ramp section and a step section to facilitate moving the seat from the upright position to the inclined position; a movable seat bottom; and a movable seat back, wherein the seat bottom and the seat back are pivotally connected to one another.

The adjustable seat may further include at least one support member that is located in the step section of the slot when the seat is in the upright position and is located at the bottom of the ramp section when the seat is in the inclined position. The frame may include three slots on each side of the seat and support members movable in each of the slots. The support members can be rods, and two of the rods can be attached to the seat bottom, and one is attached to the seat back.

The adjustable seat may further include a latch mechanism for locking the seat in the upright position. The latch mechanism may include first and second linking members, and the first linking member is pivotally connected to a support member that is movable in the slot.

Another feature of the invention is to provide an embodiment of an adjustable seat having an upright position and an inclined position for use on a watercraft, wherein the seat includes a frame; a movable seat bottom supported by the frame; a movable seat back pivotally connected to the movable seat bottom; and a latch mechanism for locking the seat in the upright position.

The latch mechanism may include a first linking member and a second linking member. The first linking member and the second linking member align in an over-center position to lock the seat in the upright position. The latch mechanism may include a release member to pull the first and second linking members from the over-center position to allow the seat to be moved to the inclined position. The linking members may be pivotally connected to one another at one end thereof, and the first linking member may be pivotally connected at the other end thereof to a support member, and the second linking member may be pivotally connected at the other end thereof to the frame. The second linking member may have a generally L-shaped configuration, and one leg of the L member contacts the frame to limit movement of the latch mechanism.

The latch mechanism may also include a resilient member biasing the latch mechanism into a locked position. The resilient member may be a spring having one end connected to the latch mechanism and a second end connected to the frame.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is a perspective view of a watercraft having an adjustable inclining seat;

FIG. 2 is a side perspective view of one embodiment of an inclining seat of the subject invention in an upright position;

FIG. 3 is a side perspective view of the adjustable inclining seat of FIG. 1 in an inclined position;

FIG. 4 is a cross-sectional view of the adjustable inclining seat in the upright position taken through the center of the seat in FIG. 2;

FIG. 5 is a cross-sectional view of the adjustable inclining seat in the inclined position taken through the center of the seat in FIG. 3;

FIG. 6 is a lower rear perspective view of the adjustable inclining seat of FIG. 2 in the upright position;

FIG. 7 is a lower rear perspective view of the adjustable inclining seat of FIG. 2 in the inclined position;

FIG. 8 is a bottom perspective view of the adjustable inclining seat of FIG. 2 in the upright position;

FIG. 8A is an enlarged view of the area indicated in FIG. 8 showing an upper end of a gas-assist strut, a mounting bracket, and a support member in a slot;

FIG. 8B is an enlarged view of the area indicated in FIG. 8 showing the base end of the gas-assist strut and a mounting bracket;

FIG. 9 is a bottom perspective view of the adjustable inclining seat of FIG. 2 in the inclined position;

FIG. 10 is a perspective view from the bottom of the seat back of the adjustable inclining seat of FIG. 2 in the upright position;

FIG. 11 is a perspective view from the bottom of the seat back of the adjustable inclining seat of FIG. 2 in the inclined position;

FIG. 12 is a perspective view of an alternate embodiment adjustable seat having a latch mechanism;

FIG. 13 is a perspective view of the seat of FIG. 12 with the latch mechanism being released;

FIG. 14 is a perspective view of the seat of FIG. 12 showing the latch mechanism position when the adjustable seat is in the inclined position;

FIG. 15 is a side view of the seat and the latch mechanism of FIG. 12 from the interior of the frame with the adjustable seat in the upright position;

FIG. 16 is a side view of the seat and the latch mechanism of FIG. 12 from the interior of the frame with the latch mechanism being released; and

FIG. 17 is a side view of the seat and the latch mechanism of FIG. 12 from the interior of the frame with the adjustable seat in the inclined position.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

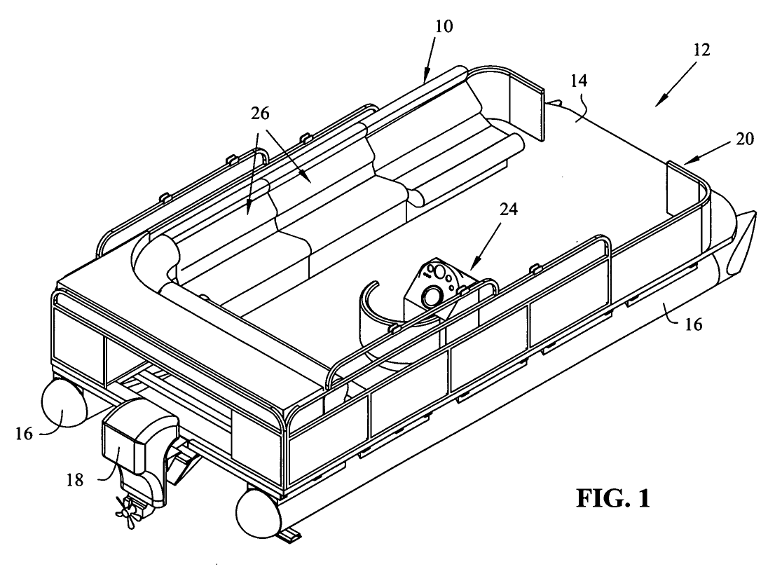

Referring to FIG. 1, an adjustable inclining seat, generally indicated as 10, is shown on a watercraft, generally indicated as 12, which in the embodiment shown, is a pontoon boat. Pontoon boat 12 is known and includes a deck 14, pontoons 16, an engine 18, a railing structure, generally indicated as 20, and a driver station, generally indicated as 24. Watercraft 12 also includes a plurality of other seats, generally indicated as 26, which may be standard known seats or adjustable inclining seats in accordance with the subject invention.

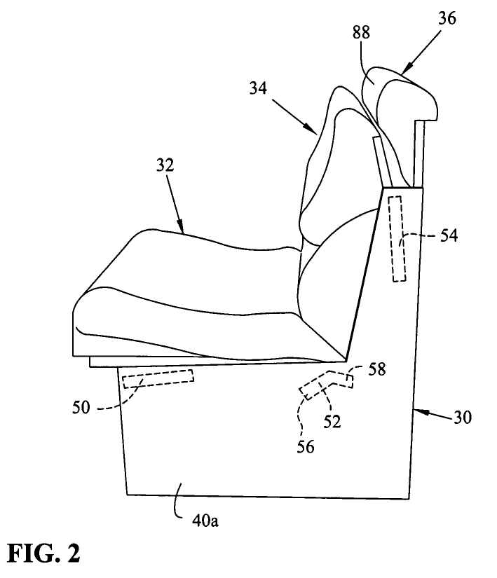

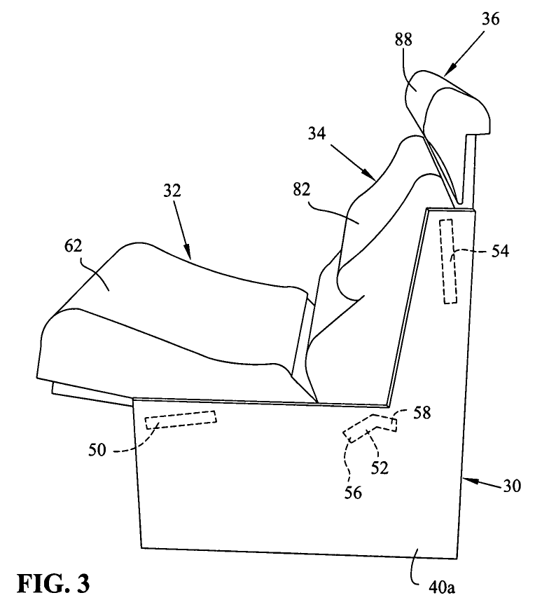

Now referring to FIGS. 2 and 3, adjustable inclining seat 10 is shown in FIG. 2 in an upright position, and in FIG. 3 in an inclined position. Adjustable seat 10 includes a frame, generally indicated as 30; a movable seat bottom, generally indicated as 32; a movable seat back, generally indicated as 34; and a headrest, generally indicated as 36.

Now referring to FIGS. 2-5, frame 30 includes a pair of end panels 40a, 40b, a front cross member 42, a pair of bottom cross members 44a, 44b, and an upper rear cross member 46. End panels 40a, 40b straddle and are located on opposite sides of seat bottom 32 and seat back 34. In the embodiment shown, each end panel 40a, 40b includes three slots or channels 50, 52 and 54. The slots or channels may extend partially into the inside surface of each end panel or completely through end panels 40a, 40b. Also, if the slots extend all the way through end panels 40a, 40b, a cover may be placed over the slots on the outer surfaces of the end panels. In the embodiment shown, slots 50 are straight and located toward the front portion of the end panels in an orientation that is slightly askew from the horizontal. Slots 52 are located in the mid portion of end panels 40a, 40b and include a ramp portion or section 56 and an angled or step portion/section 58. Slot 54 is located in the upper rear portion of end panels 40a, 40b and is straight and located at an orientation that is slightly askew from the vertical. It should be appreciated that end panels 40a, 40b may be made from any suitable material, such as wood, fiberglass, plastic or aluminum.

Cross members 42, 44a, 44b, and 46 are mounted to and extend transversely between end panels 40a, 40b and may be made from suitable structural materials, such as wood or aluminum. Also, the cross members are shown in a rectangular configuration, but it should be appreciated that any suitable structural configuration, such as angles, tubes, C-channels, or I-members may be used. The cross members are attached to the end panels using known techniques, such as with fasteners, adhesives, or by welding, if suitable materials are employed.

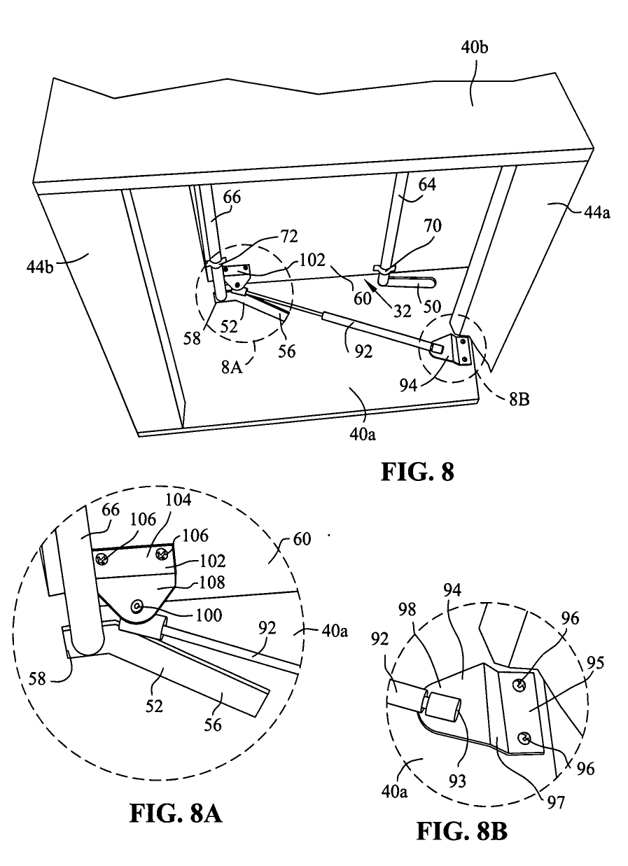

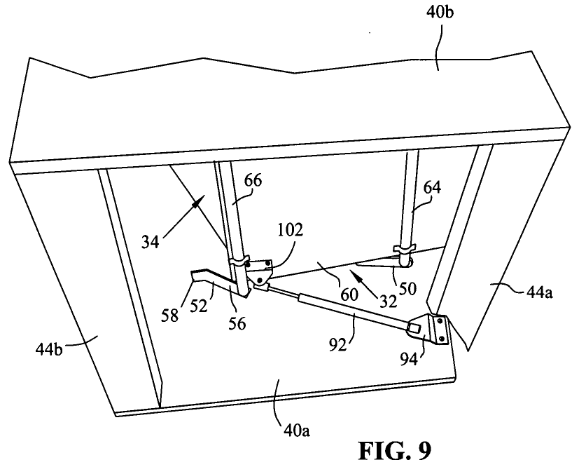

Movable seat bottom 32 includes a support panel 60 and a padded portion 62 mounted on top of support panel 60. Panel 60 may be made from wood, blow-molded plastic, aluminum, or any other suitable material, and padded portion 62 may be made from known padding materials and covered with a fabric material that is preferably moisture-resistant, such as vinyl. Movable seat bottom 32 also includes a pair of support members 64, 66, which in the embodiment shown are cylindrical rods or dowels that extend transversely across and beneath support panels 60, as best shown in FIGS. 8 and 9. Rods 64, 66 are mounted to support panel 60 with brackets 70, 72, respectively, which may be affixed to support panel 60 using fasteners, such as screws. The ends of rods 64, 66 extend beyond support panel 60 and are slidably positioned in slots 50, 52, respectively, to facilitate adjustment of inclining seat 10, as is discussed in further detail below.

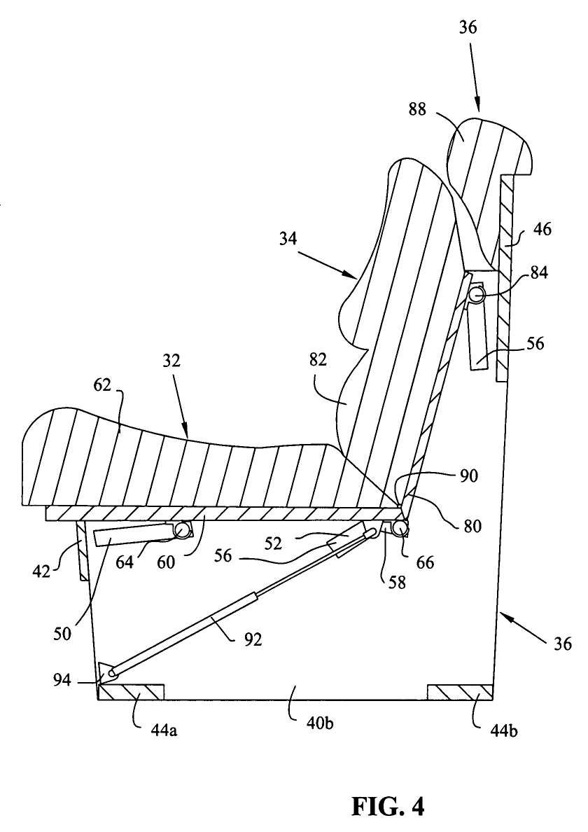

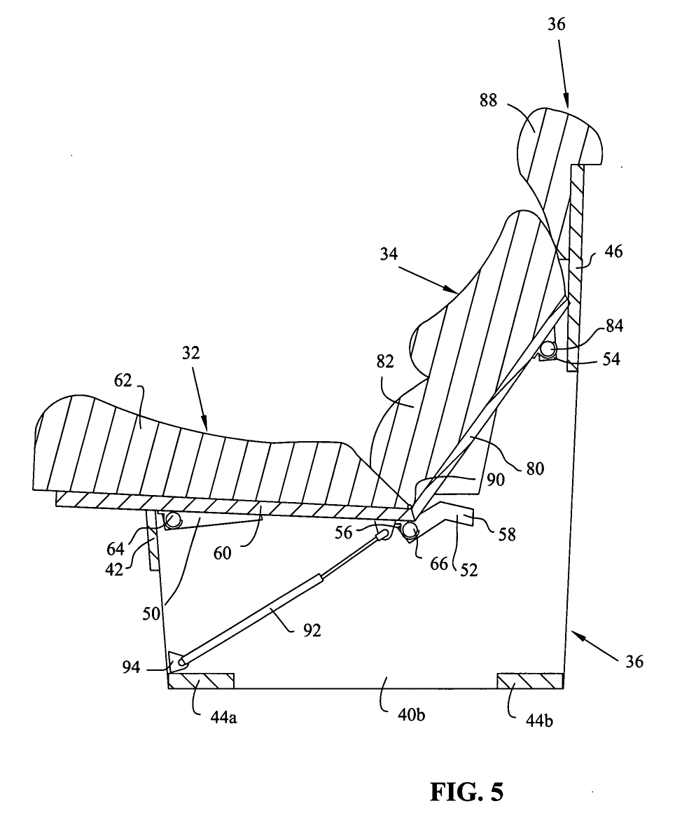

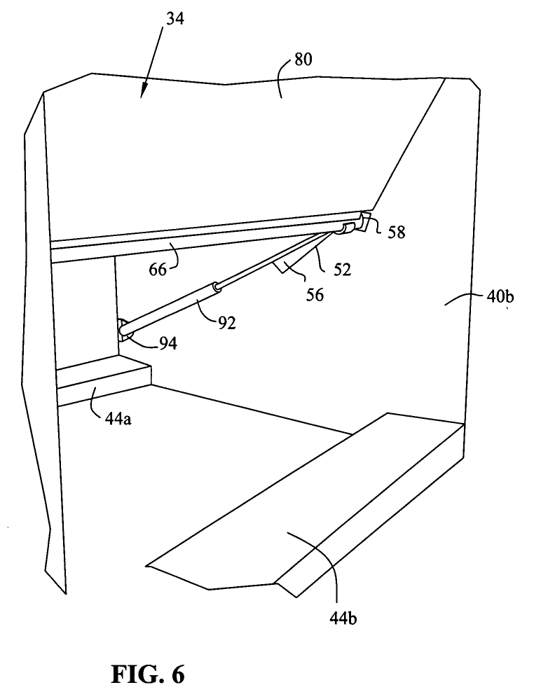

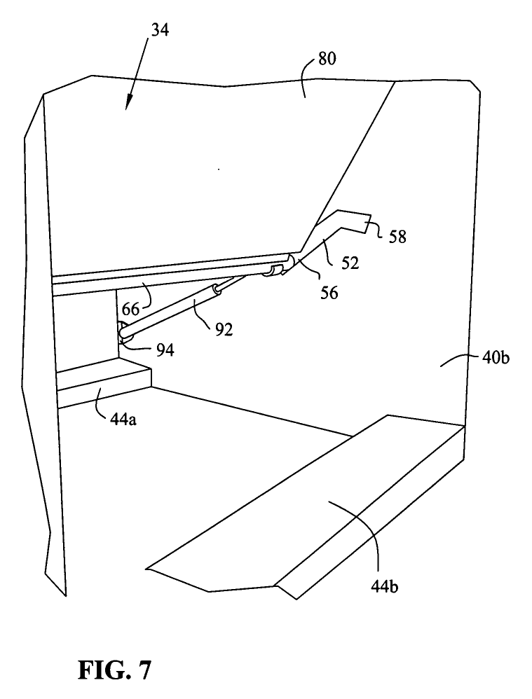

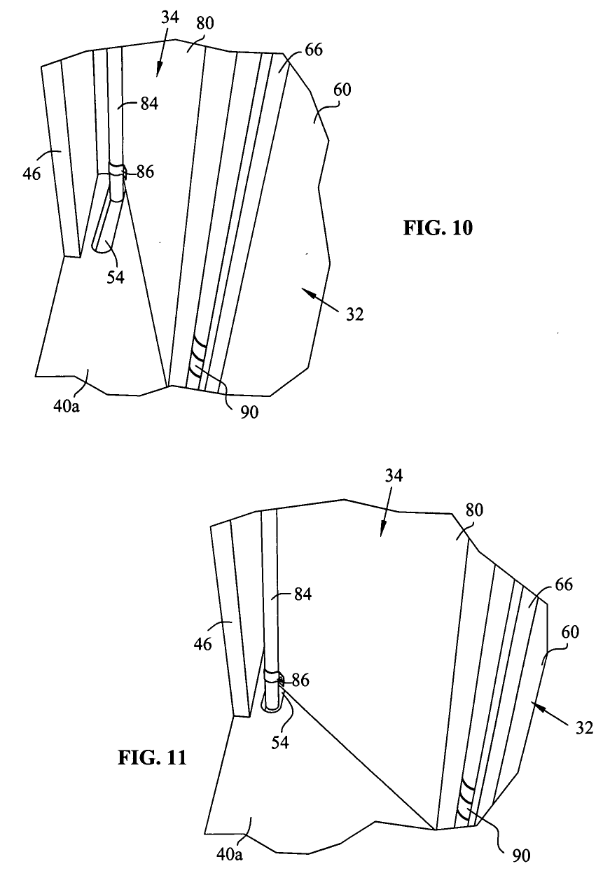

Referring again to FIGS. 4 and 5, movable seat back 34 includes a support panel 80 and a padded portion 82 mounted to support panel 80. Panel 80 and padded portion 82 may be made from similar materials as panel 60 and padded portion 62, respectively. Seat back 34 also includes a support member, which, in the embodiment shown, is a cylindrical rod or dowel 84 mounted to and extending transversely across the back of support panel 80, as best shown in FIGS. 10 and 11. Rod 84 is mounted to support panel 80 with brackets 86, which may be attached to the support panel with fasteners, such as screws. The ends of rod 84 extend beyond support panel 80 and are slidably located in slots 54 to facilitate adjustment of inclining seat 10, as is discussed below in further detail.

Headrest 36 consists of a padded portion 88 that is fixedly mounted to rear cross member 46. Like padded portions 62, 82, padded portion 88 may be made from known padding materials and covered with a moisture-resistant material, such as vinyl.

Inclining seat 10 also includes hinges 90 that pivotally connect support panel 60 of seat bottom 32 and support panel 80 of seat back 34 to one another, as best shown in FIGS. 4, 5, 10, and 11. Inclining seat 10 also includes a pair of known gas-assist struts or shocks 92 to help keep inclining seat 10 from accidentally slipping out of the upright position and to assist in moving inclining seat 10 from the inclined position to the upright position. The base end of each gas-assist strut is pivotally mounted at 93 to bracket 94, which are mounted to respective end panels 40a, 40b, as best shown in FIGS. 8 and 8B. Brackets 94 include a base portion 95 that is mounted with fasteners, such as screws 96, to the end panels, an angled portion 97, and a raised portion 98, wherein pivot connection 93 is located. The upper extendable end of each gas-assist struts 92 is pivotally connected at 100 to respective brackets 102, which are mounted to support panel 60, as best shown in FIGS. 8 and 8A. Brackets 92 have an L-shaped cross-section and include a base leg 104 that is mounted to support panel 60 with screws or other fasteners 106 and an upstanding leg 108, wherein pivot connection 100 is located.

Inclining seat 10 is mounted to deck 14 for use as shown in FIG. 1 to provide a seat that can be used in the standard upright position as shown in FIG. 2 or can be moved to the inclined position as shown in FIG. 3 for increased relaxation. Inclining seat 10 is moved between the upright and inclined positions by moving or sliding the ends of support rods 64, 66, and 84 in the respective slots 50, 52, and 54. In the upright position, rod 64 is located toward the back end of slot 50, while rod 66 is in the step section 58 of slot 52, as best shown in FIGS. 4 and 8. Support rod 84 is located at the top of slot 54 in the upright position, as best shown in FIGS. 4 and 10.

To move seat 10 to the inclined position, movable seat bottom 32 is pulled forward so that rod 64 slides to the front of slot 50, and rod 66 slides down to the bottom of ramp section 56, as best shown in FIGS. 5 and 9. As seat back 34 is connected to seat bottom 32 by hinges 90, rod 84 will also move down to the bottom of slot 54, as shown in FIGS. 5 and 11, as the seat bottom is moved. As can be seen from the figures, when seat 10 is moved to the inclined position, the front portion of seat bottom 32 will extend further forward, while the rear portion is lowered because of rod 66 moving to the bottom of ramp section 56. In this position, the top surface of seat 32 will move from a generally horizontal orientation to an orientation that is at a greater angle from the horizontal. Also, it should be appreciated that seat back 34 is located generally lower in the inclined position than in the upright position and that it is at a greater angle relative to the vertical in the inclined position than in the upright position.

As best seen in FIGS. 4 and 5, step section 58 of slot 52 may have a slight backward angle to help keep inclining seat 10 from accidentally moving from the upright position to the inclined position. A lip may also be provided in the slot at the juncture between ramp section 56 and step section 58 so that seat 10/support rod 66 must be lifted slightly before being moved to the inclined position. Also, gas-assist struts 92 are oriented to provide a force that pushes seat 10 to the upright position to help keep the seat from inadvertently slipping to the inclined position.

When it is desired to move the seat back from the inclined position of FIG. 3 to the upright position of FIG. 2, the rear portion of seat bottom 32 is pushed or pulled to move rod 66 back up ramp section 56 of slot 52 and into step section 58. Rods 64 and 84 will likewise move to their respective rear and top positions in respective slots 50 and 54, when the seat is moved back to the upright position, as shown in FIG. 4. Also, it should be appreciated that gas-assist struts 92 will assist in pushing seat 10 back to the inclined position.

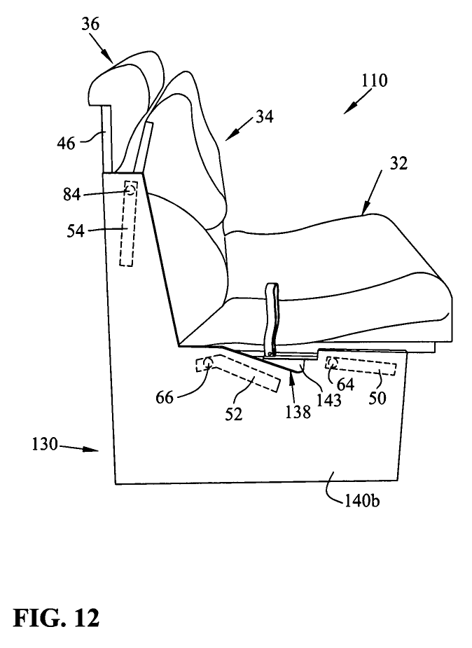

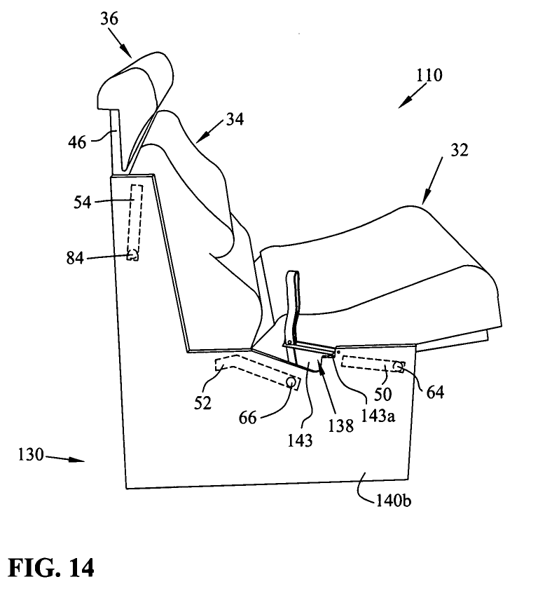

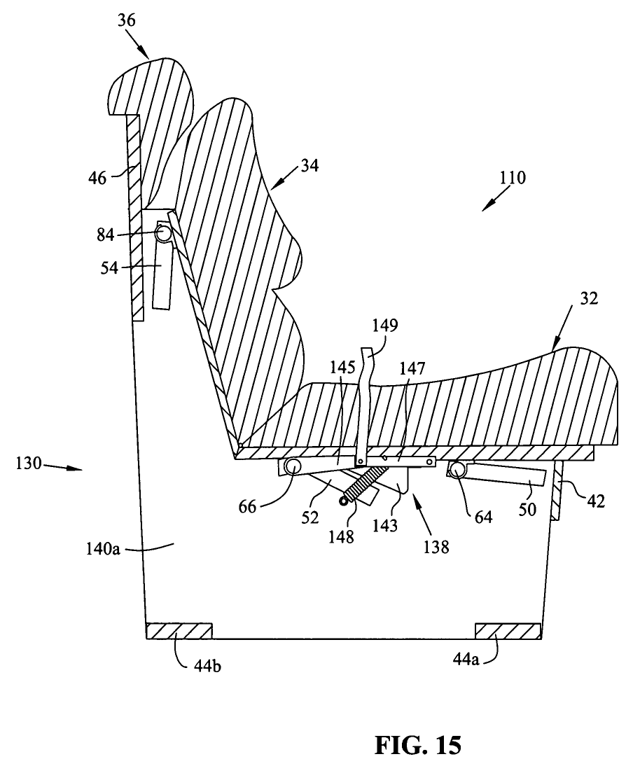

Now referring to FIGS. 12-17, another embodiment of an adjustable inclining seat is shown, generally indicated as 110. Adjustable seat 110 is also movable between an upright position (FIGS. 12 and 15) and an inclined or reclining position (FIGS. 14 and 17). Adjustable seat 110 is similar in most respects to seat 10 except that it includes a modified frame, generally indicated as 130, and a latch mechanism, generally indicated as 138, for locking seat 110 into the upright position. Frame 130 includes modified end panels 140a and 140b having a notched area 143, wherein latch mechanism 138 is located, and an upper end segment 143a that serves as a stop for latch mechanism 138.

As shown in the embodiment depicted, latch mechanism 138 may be of the type that is commonly referred to as an “over-center” type latch. Latch mechanism 138 includes a first linking member 145, a second linking member 147, a resilient member 148, and a release member 149. Linking member 145 is pivotally connected at one end to support rod 66 and pivotally connected at the other end to linking member 147. In addition to being pivotally connected to linking member 145 at one end, linking member 147, which may have an L-shaped or T-shaped configuration, is pivotally connected at its other end-to-end panel 140a or 140b using rivets, other fasteners and/or a bracket. Resilient member 148, which is a coil spring in the embodiment shown, is mounted at one end to the respective end panel 140a or 140b using a screw or other fastener, and the other end is hooked in a notch located in linking member 147. Release member 149, which may be a looped strap, is pivotally connected to the latch mechanism at the same connection where linking members 145 and 147 are connected.

In use, resilient member 148 pulls latch mechanism 138 to the over-center locked position when adjustable seat 110 is in the upright position as shown in FIGS. 12 and 15. Additionally, upper end segment 143a of end panel 140a or 140b acts as a stop by contacting one leg of linking member 147 to prevent resilient member 148 from pulling latch mechanism 138 beyond the over-center position. While latch mechanism 138 remains in the over-center position, it locks adjustable seat 10 and keeps the seat from being unintentionally or accidentally moved to the inclined position.

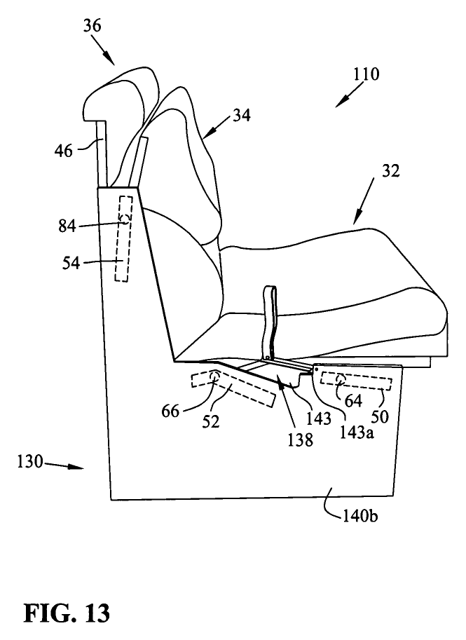

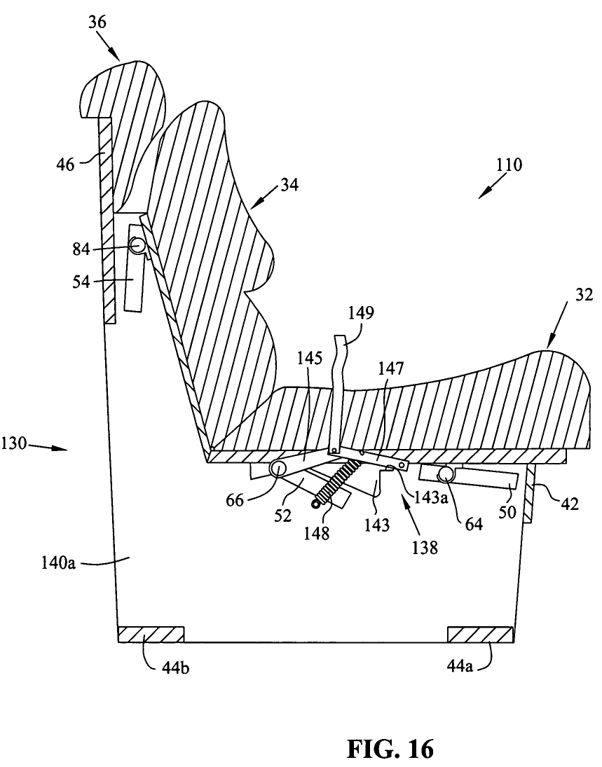

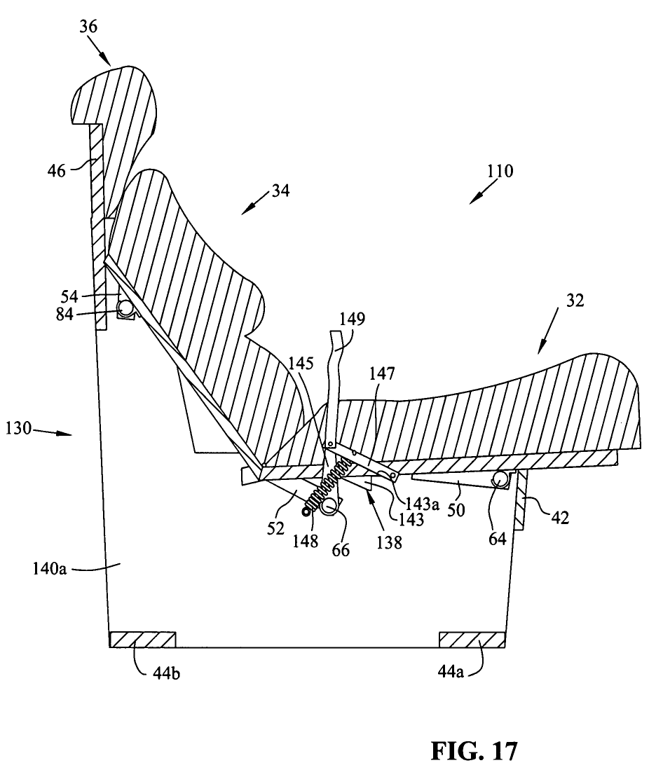

When it is desired to move adjustable seat 110 to the inclined position, release mechanism 149 is pulled upward to release latch mechanism 138 from the over-center position to the intermediate position shown in FIGS. 13 and 16. When latch mechanism 138 is released from the over-center position, the seat can then be easily moved to the inclined position shown in FIGS. 14 and 17 by moving the support rods, as discussed above. It should be appreciated that, when moving the seat between the upright and inclined positions, linking members 145 and 147 will pivot on their respective end connections. As adjustable seat 110 is stable when in the inclined position with rod 66 located at the bottom of slot 52, it is not necessary to lock it in this position.

When adjustable seat 110 is moved back to the upright position, resilient member 148 will automatically pull the latch mechanism back to the locked over-center position, wherein unintentional movement out of the upright position is again prevented.

While the invention has been taught with specific reference to these embodiments, one skilled in the art will recognize that changes can be made in form and detail without departing from the spirit and scope of the invention. For example, although seat 10 is shown only on a pontoon boat, it should be appreciated that the seat may be used on any watercraft or in other vehicles, such as an RV. In addition, support panels 60 and 80 may be provided with a framework-type configuration formed from structural members, as opposed to being provided as a solid or hollow panel member. Also, the shape and configuration of both the end panels of the frame and the slots contained therein may be varied to any suitable configuration and more or fewer slots may be provided.

Furthermore, support members 64, 66, and 84 need not extend completely across the width of the seat and may consist of shorter sections attached where desired on each side of the seat bottom and seat back. In addition, it should be appreciated that a locking mechanism may be provided that is required to be released before moving the chair from the upright to the inclined position. The described embodiments are to be considered, therefore, in all respects only as illustrative and not restrictive. As such, the scope of the invention is indicated by the following claims rather than by the description.

1. A watercraft comprising:
a deck;
an engine; and
at least one adjustable seat, including a seat bottom and a seat back, said seat being adjustable from an upright position to an inclined position, wherein said seat bottom is located forward from the location of said seat bottom in the upright position.

2. The watercraft as set forth in claim 1, wherein a rear portion of said seat bottom is located lower in the inclined position than in the upright position.

3. The watercraft as set forth in claim 2, wherein an upper surface of said seat bottom is at a greater angle relative to the horizontal in the inclined position than in the upright position.

4. The watercraft as set forth in claim 1, wherein said seat back is located lower in the inclined position than in the upright position.

5. The watercraft as set forth in claim 4, wherein said seat back is at a greater angle relative to the vertical in the inclined position than in the upright position.

6. The watercraft as set forth in claim 1, wherein said seat bottom and said seat back are pivotally connected to one another with a hinge.

7. The watercraft as set forth in claim 1, wherein said seat further includes a frame and slots in said frame that facilitate the adjustment of said seat.

8. The watercraft as set forth in claim 7, wherein said frame includes a pair of ends, one each on opposite sides of said seat back and said seat bottom, with three slots in each end.

9. The watercraft as set forth in claim 8, wherein two of said slots in each end are straight, and one of said slots on each end includes an angled portion.

10. The watercraft as set forth in claim 7, including at least one support member attached to either said seat back or said seat bottom, and ends of said support member being located in said slots of said frame, said seat moved from the upright position to the inclined position by sliding said ends of said support member in said slot.

11. The watercraft as set forth in claim 10, including three support members, two of said support members being attached to said seat bottom and one support member attached to said seat back.

12. The watercraft as set forth in claim 7, wherein said seat further includes a headrest mounted to said frame.

13. The watercraft as set forth in claim 12, wherein said seat bottom and said seat back are movable relative to said headrest.

14. The watercraft as set forth in claim 1, wherein said seat is manually movable between the upright position and the inclined position.

15. The watercraft as set forth in claim 1, further including a latch mechanism to lock said seat in the upright position.

16. The watercraft as set forth in claim 15, wherein said latch mechanism includes first and second linking members that are aligned in an over-center position to lock said seat in the upright position.

17. A watercraft comprising:
a deck;
an engine; and
at least one adjustable seat, including a seat bottom and a seat back, said seat being adjustable from an upright position to an inclined position, wherein said seat back is at a greater angle relative to the vertical in the inclined position than in the upright position.

18. The watercraft as set forth in claim 17, wherein said seat back is located lower in the inclined position than in the upright position.

19. The watercraft as set forth in claim 17, wherein in the inclined position, said seat bottom is located forward of the location of said seat bottom in the upright position.

20. The watercraft as set forth in claim 18, wherein said seat bottom is at a greater angle relative to the horizontal in the inclined position than in the upright position.

21. The watercraft as set forth in claim 17, wherein said seat bottom and said seat back are pivotally connected to one another.

22. The watercraft as set forth in claim 17, wherein said seat includes a frame and said frame has slots that facilitate the adjustment to said seat.

23. The watercraft as set forth in claim 22, wherein said frame has two opposite ends located on opposite sides of said seat back and said seat bottom, and each end has three slots.

24. The watercraft as set forth in claim 23, wherein two of said slots on each end are straight, and one of said slots on each end has an angled portion.

25. The watercraft as set forth in claim 22, wherein said seat includes at least one support member, and an end of said support member is located in one of said slots, said end of said support member sliding in said slot when moving said seat from the upright position to the inclined position.

26. An adjustable seat having an upright position and an inclined position for use on a watercraft, said seat comprising:
a frame;
a movable seat bottom, a portion of said seat bottom being lower in the inclined position than in the upright position; and
a movable seat back, said seat back being lower in the inclined position than the upright position.

27. The adjustable seat as forth in claim 26, wherein said seat back and said seat bottom are pivotally connected to one another, and said seat back and said seat bottom are padded.

28. The adjustable seat as forth in claim 26, wherein in the inclined position, said seat bottom is located forward from the location of said seat bottom in the upright position, and an upper surface of said seat bottom is at a greater angle relative to the horizontal in the inclined position than in the upright position.

29. The adjustable seat as forth in claim 26, wherein said frame includes slots that facilitate the adjustment of said seat, and said frame further including a pair of ends, one each on opposite sides of said seat back and said seat bottom, said slots being located in said ends.

30. The adjustable seat as forth in claim 29, wherein at least one of said slots includes a ramp section and a step section.

31. The adjustable seat as forth in claim 30, further including a support member having an end in one of said slots, said support member end being located in said step section when said seat is in the upright position and being located at the bottom of said ramp section when said seat is in the inclined position.

32. The adjustable seat as forth in claim 29, including three slots in each end of said frame and support members, with one support member supported in each slot, said support members sliding in said slots to move said adjustable seat from the upright position to the inclined position.

33. The adjustable seat as forth in claim 26, further including a headrest mounted to said frame, said seat back and said seat bottom being movable relative to said headrest.

34. The adjustable seat as forth in claim 26, including at least one gas-assist strut to aid in raising said seat to the upright position.

35. The adjustable seat as forth in claim 26, further including a latch mechanism to lock said seat in the upright position.

36. The adjustable seat as forth in claim 35, wherein said latch mechanism includes pivoting linking members and a release member to pull the linking members from an over-center position.

37. An adjustable seat having an upright position and an inclined position for use on a watercraft, said seat comprising:
a frame;
a movable seat bottom having an upper surface that is at a greater angle relative to the horizontal in the inclined position than in the upright position; and
a movable seat back, said seat back being at a greater angle relative to the vertical in the inclined position than in the upright position.

38. The adjustable seat as forth in claim 37, wherein a rear portion of said seat bottom is located lower in the inclined position than in the upright position, and said seat back is located lower in the inclined position than in the upright position.

39. The adjustable seat as forth in claim 37, including a gas-assist strut connected between said frame and one of either said seat bottom or said seat back.

40. The adjustable seat as forth in claim 37, wherein said frame includes at least one slot to facilitate movement of said adjustable seat from the upright position to the inclined position, and said seat further includes a support member movable in said slot.

41. The adjustable seat as forth in claim 40, wherein said frame includes three slots on each side of said seat, and support members movable in each of said slots.

42. The adjustable seat as forth in claim 41, wherein said support members are rods, two of which are attached to said seat bottom, and one being attached to said seat back.

43. The adjustable seat as forth in claim 40, wherein said slot includes a ramp section and a step portion, said support member being located in said step section when said seat is in the upright position, and said support member being located at the bottom of said ramp section when said seat is in the inclined position.

44. An adjustable seat having an upright position and an inclined position for use on a watercraft, said seat comprising:
a frame having at least one slot;
a movable seat bottom;
a movable seat back; and
a support member movable in said slot, to move said seat from the upright position to the inclined position.

45. The adjustable seat as forth in claim 44, wherein said slot includes a ramp section and a step section, said support member being in said step section when said seat is in the upright position, and being at the bottom of said ramp section when said seat is in the inclined position.

46. The adjustable seat as forth in claim 44, wherein said frame includes three slots on each side of said seat, and a support member in each of said slots.

47. The adjustable seat as forth in claim 46, wherein said support members are rods, and two of said rods are attached to said seat bottom and one of said rods is attached to said seat back.

48. The adjustable seat as forth in claim 44, wherein said seat bottom and said seat back are pivotally connected to one another.

49. An adjustable seat having an upright position and an inclined position for use on a watercraft, said seat comprising:
a frame having at least one slot, said slot having a ramp section and a step section to facilitate moving said seat from the upright position to the inclined position;
a movable seat bottom; and
a movable seat back, said seat bottom and said seat back being pivotally connected to one another.

50. An adjustable seat having an upright position and an inclined position for use on a watercraft, said seat comprising:
a frame;
a movable seat bottom supported by said frame;
a movable seat back pivotally connected to said movable seat bottom; and
a latch mechanism for locking said seat in the upright position.
